(19) United States
(12) Patent Application Publication
(10) Pub. No.: US 2003/0122659 A1
(43) Pub. Date: Jul. 3, 2003

(54) Vehicle backup alert system

(75) Inventor: Ching Wung Lam, Hong Kong (CN)

Correspondence Address: Irving Keschner, 21515 Hawthorne Boulevard, Torrance, CA, 90503, US

(73) Assignee: Poron International, Ltd.

(21) Appl. No.: 10/033,352

(22) Filed: Dec. 28, 2001

(51) Int. Cl. B60Q 1/00

(52) U.S. Cl. 340/435

(57) ABSTRACT

A vehicle backup alert system using messaging system that announce the distance between the vehicle and an obstacle therebehind. A main control unit (MCU) powered by the vehicle battery, controls a speaker positioned in the vehicle cabin and at least one ultrasonic transducer mounted on the exterior of the vehicle and positioned to generate sound waves that scan a wide field of view behind the vehicle. The MCU is activated when the vehicle is in reverse. Once activated, the MCU causes a sensor to generate a sensor signal which is incident on an obstacle (if present) behind the vehicle. The signal reflected from the obstacle is processed and fed back to the MCU. The MCU software then determines if the echo signal has detected an object. If yes, the voice module is activated and the speaker announces the distance to the object in a variable tone and the cycle is repeated. If the echo signal has not detected an object and the object has not moved into a blind area, the signal is again transmitted by the MCU. If the object has moved into a blind are, a signal is sent to the voice module which announces that the object is in the blind area and repeats that message until an object is detected behind the vehicle.

### BACKGROUND OF THE INVENTION

1. Field of the Invention

A vehicle alert system that provides a continuous voice signal indicating how far an obstacle is behind the vehicle when the vehicle is in reverse.

2. Description of the Prior Art

Warning systems associated with various types of vehicles have been available in the prior art for many years. For example, vehicle display warning systems wherein a display is positioned on or near the rear window of a vehicle and wherein a display control panel is positioned for access by the driver, the driver causing a message to appear on the display, has been disclosed in U.S. Pat. No. 4,868,542 to Thompson. In particlular, the '542 patent discloses an automobile signaling system which includes a processing unit mounted in the vehicle adjacent the driver, the output from the unit being coupled to a display unit mounted in the vehicle rear window. A warning message is displayed on the display unit when the vehicle brakes are activated. In addition a number of vehicles, particularly those used commercially, include systems which produce audio warning signals when the vehicles are backing up. Neither of these types of vehicle alert systems disclose devices for providing a voice message alerting the driver as to the distance between the vehicle and the obstacle therebehind. Providing such a message would provide the driver with an accurate distance measurement to the obstacle, something which would be difficult to ascertain by a visual observation of the situation.

What is thus desired is to provide a system which continuously alerts the driver by a voice message as to the distance between the vehicle and an obstacle behind the vehicle when the vehicle is in reverse.

### SUMMARY OF THE INVENTION

The present invention provides a vehicle backup alert system using messaging system that announce the distance between the vehicle and an obstacle therebehind.

A main control unit (MCU) powered by the vehicle battery and activated when the vehicle is in reverse, controls a speaker positioned in the vehicle cabin and at least one ultrasonic transducer mounted on the exterior of the vehicle. The transducer generates ultrasonic waves that scan a predetermined field of view behind the vehicle; ultrasonic waves incident on an obstacle (if present) behind the vehicle are reflected from the obstacle (echo signals), processed and fed back to the MCU (the MCU includes a microprocessor). The MCU software then determines if the echo signal has detected an object. If yes, the voice module is activated and the speaker announces the distance to the object in a variable tone and the cycle is repeated. If the echo signal has not detected an object and the object has not moved into a blind area, the ultrasonic signal is again transmitted by the MCU. If the object has moved into a blind area, a signal is sent to the voice module which announces that the object is in the blind area and repeats that message until an object is detected behind the vehicle.

The present invention thus provides a vehicle backup system which alerts the driver, by a voice message, if an object is behind the vehicle and, if so, the distance to the object. The use of an electronic device which provides a voice message continually announcing the distance to an obstacle provides the driver with an increased safety margin then otherwise is available by visually looking through the rear view mirror or directly through the rear window.

### DESCRIPTION OF THE DRAWINGS

For a better understanding of the present invention as well as other objects and further features thereof, reference is made to the following description which is to be read in conjunction with the accompanying drawing therein:

FIG. 1 is a simplified drawing of a vehicle using the system of the present invention is illustrated;

FIG. 2 is a simplified view of the interior of a vehicle;

FIG. 3 is a simplified block diagram of the vehicle backup alert system of the present invention;

FIG. 4 is a schematic drawing of the block diagram shown in FIG. 3;

FIG. 5 is a flowchart illustrating the operation of the MCU; and

FIGS. 6 and 7 are flowcharts illustrating the operation of the MCU.

### DESCRIPTION OF THE INVENTION

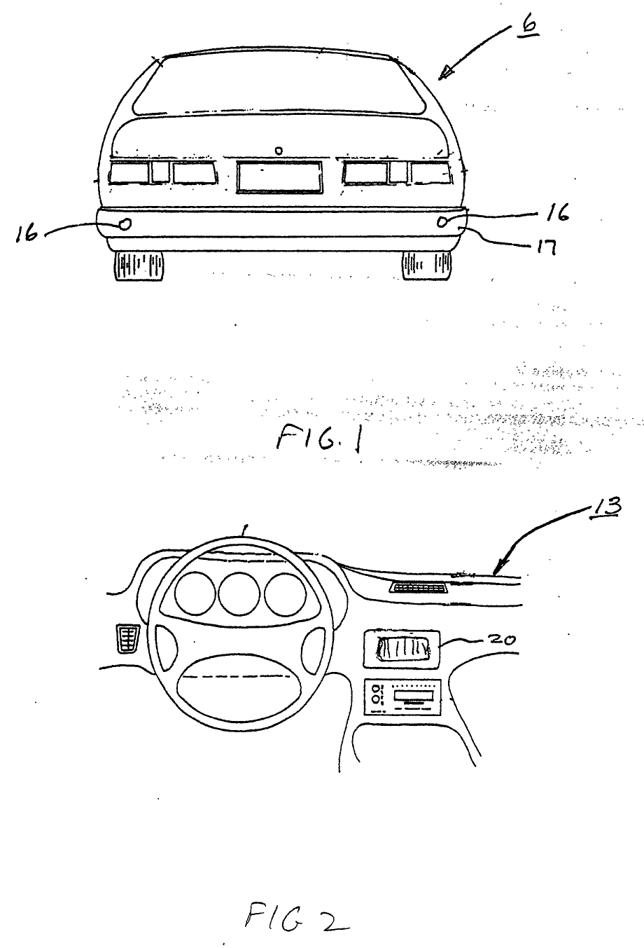

FIG. 1 shows a rear view of a conventional vehicle 6. Mounted on the outside rear portion of vehicle 6 are a plurality of transmitter/receiving sensors 16, the function of which will be described hereinafter.

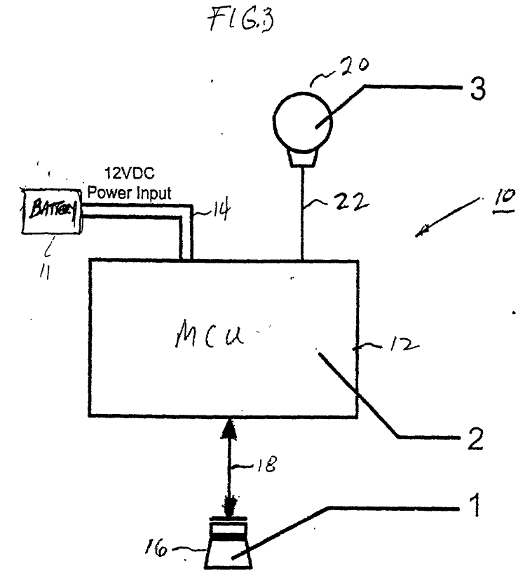

FIG. 2 shows the interior dashboard 13 of the vehicle 6 and incorporates the conventional accessories. In accordance with the teachings of the present invention, a separate speaker 20 is provided that, as will be described hereinafter, provides voice and tone audio signals which alert the driver as to the distance that an obstacle is behind the vehicle 6. Although speaker 20 is illustrated as being mounted dashboard 13 of vehicle 6, the speaker can be positioned loosely within the interior of vehicle 6, preferably adjacent the driver so that the alert signals can be heard.

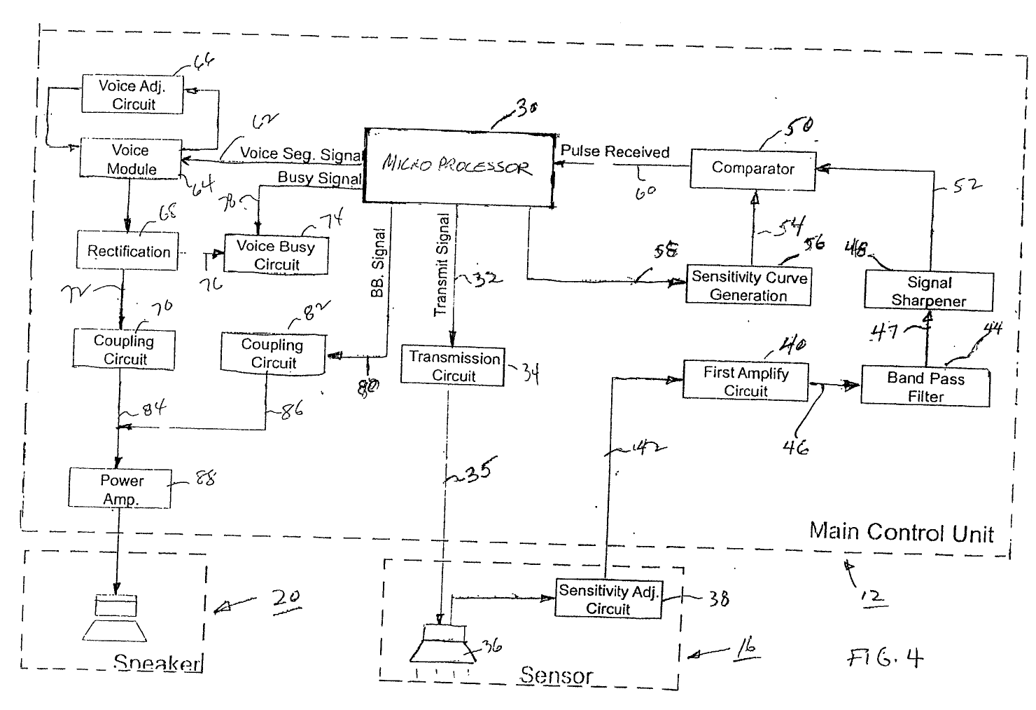

Referring now to FIG. 3, a simplified block diagram of the vehicle backup alert system 10 of the present invention is illustrated. In particular, system 10 comprises a main control unit (MCU) 12 powered by the vehicle battery 11 (12 VDC) via leads 14. MCU 12 controls ultrasonic sensor 16 (sensor 16 has the capability of both transmitting and receiving ultrasonic waves of a predetermined frequency) via data lead 18 and speaker 20 via lead 22. System 10 may comprise a single sensor 16, or a plurality of such sensors as illustrated, mounted to the rear bumper 17 of vehicle 6.

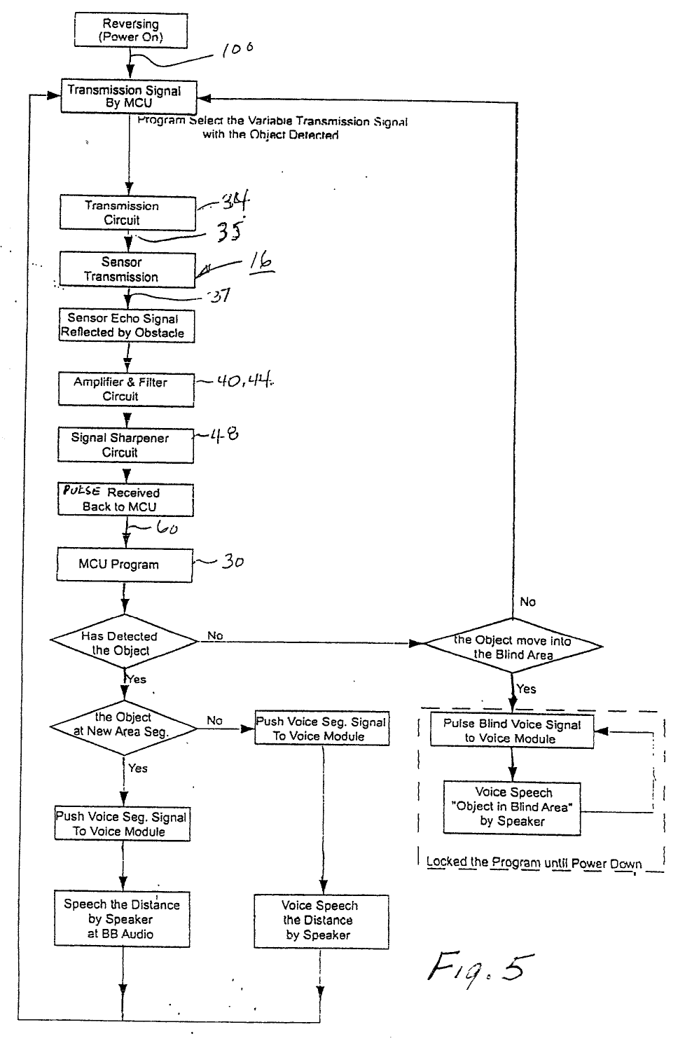

Referring now to the schematic shown in FIG. 4, the MCU 12 comprises a microprocessor 30, such as the Zilog model number Z806e08, manufactured by Zilog, Inc., Campbell, Calif., which generates a transmit signal at output port 32, the output signal being coupled to transmission circuit 34. The output of transmission circuit 34 is then coupled to ultrasonic transmitter/receiver unit 36 in sensor 16 via lead 35. The output of the receiver portion of unit 36 is coupled to sensitivity adjustment circuit 38, the output thereof being coupled to amplifier 40 via lead 42. The output of amplifier 40 is coupled to bandpass filter 44 via lead 46. The signal on output lead 47 is connected to signal sharpener 48 (clears and sharpens echo signal), the output of which is connected to comparator 50 via lead 52. Comparator 50 compares the signal on lead 52 with the output on lead 54 generated by sensitivity curve generator 56 which in turn is controlled by the sensitivity signal on lead 58 generated at the output port of microprocessor 30. The receiving sensitivity controlled by comparison curve generator 56 when the microprocessor 30 generates a transmission pulse; microprocessor 30 in response to the pulses received on lead 60 causes a signal to be generated which forms a comparison curve. The received echo signal is compared to the comparison curve and the sensitivity level is adjusted automatically in order to pre-set the sensitivity level to take into account the range of distances to the obstacle. The comparator output on lead 60 is received by microprocessor 30 which then generates the appropriate feedback signal on lead 58. Microprocessor 30 generates distance-voice segments signals stored in the sound chip on lead 62 which is coupled to voice module 64, the voice adjustment circuit 66 presetting the speed of the speaking voice generated by voice module 64. The output of voice module 64 is rectified by circuit 68, the output of which is coupled to circuit 70 (circuit 70 converts digital signals generated by microprocessor 30 to analog audio warning sounds) via lead 72 and to voice busy circuit 74 via lead 76. If circuit 74 determines that voice module 64 is currently providing a message, microprocessor 30 is alerted by a signal on lead 78, the microprocessor 30 in response issuing a signal on lead 80 to circuit 82 (circuit 82 converts digital warning signals on lead 80 to analog audio warning signals). The output of coupling circuit 70 and 82 on leads 84 and 86, respectively, are coupled to amplifier 88, the output of amplifier 88 in turn being coupled to speaker 20.

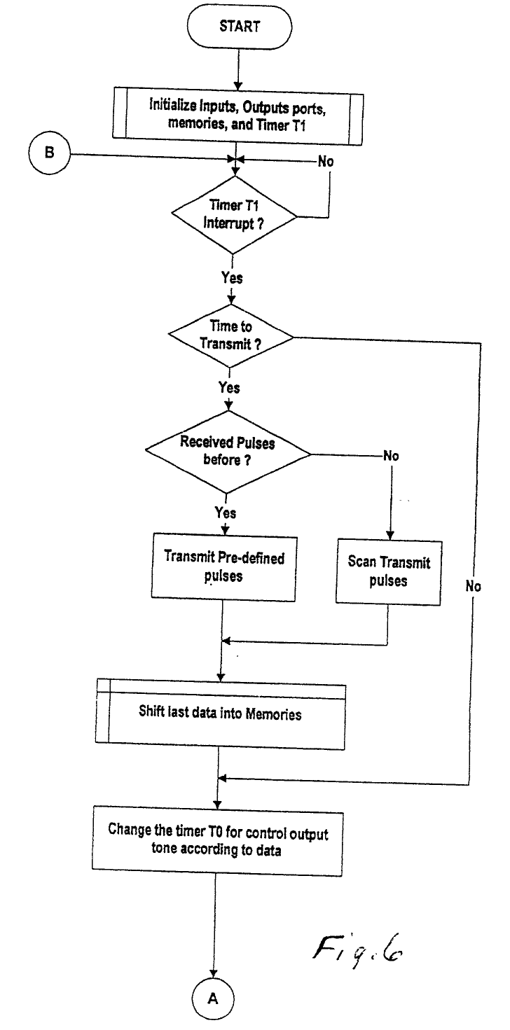

Referring now to FIG. 5, a flow chart of the system operation is illustrated.

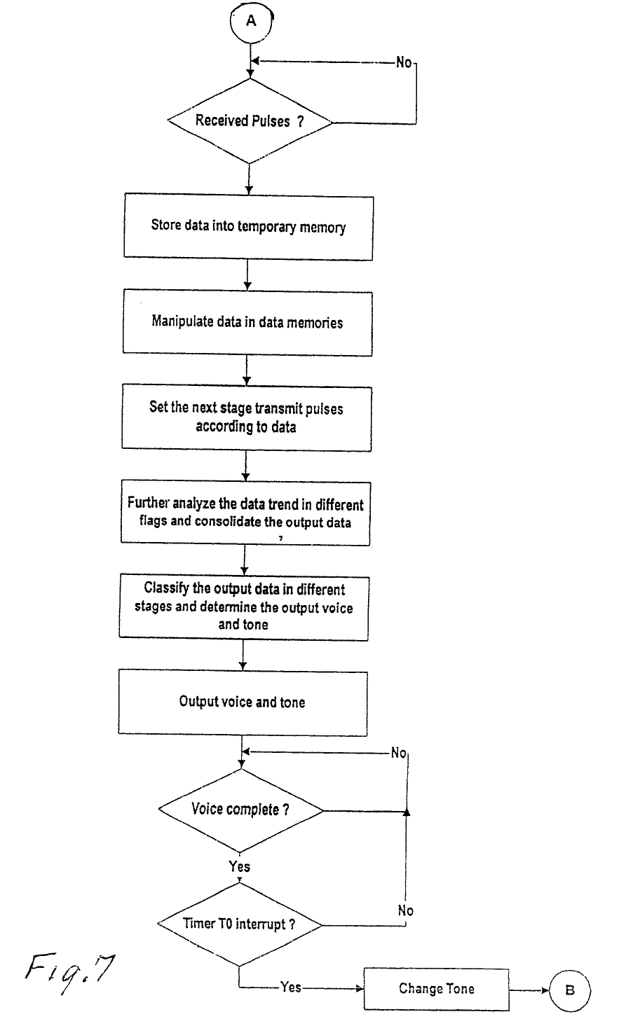

When the vehicle 6 is in reverse, a signal is generated on lead 100 which causes MCU 12 to be activated and causes transmission circuit 34 to generate a transmission signal on lead 35 (FIG. 2). Sensor 16 then transmits an echo signal 37 which is reflected back towards the sensor if an obstacle is detected. The detected signal is amplified, filtered and sharpened and coupled to microprocessor 30. The microprocessor software (see FIGS. 6 and 7 for the software routines) then determines if an object has been detected (during detection, another obstacle found at new distance range); if yes and the object is at a new area, a signal is sent to the voice module 64 (according to the distance calculated to the obstacle, microprocessor 30 causes the internal sound chip to release audio tones) and then to the speaker 20 and then back to microprocessor 30 to repeat the process. If the object is not in a new area, or range, voice module 64 is activated, coupled to speaker 20 and then back to microprocessor 30 as the process is repeated (in this case, according to the distance calculated to the obstacle microprocessor 30 causes the sound chip to release words to annunciate the calculated distance).

If an object is not detected and the object is not in a blind area, the continuous scanning process is repeated as long as the vehicle is in reverse. If the object is in a blind area, the voice module activates the speaker 20 in a manner such that the message “OBJECT IN BLIND AREA” is announced to the vehicle driver. In essence, if the obstacle has been detected once and suddenly disappears, and the set conditions in the computer program are matched, MCU 12 determines that the obstacle, or object, falls in the vehicle “blind area” and warns the driver that the object is in the blind area.

Referring to FIGS. 6 and 7, flow charts for the microprocessor 30 software is set forth.

Upon receiving a signal that the vehicle is in reverse, microprocessor 30 starts and initializes the input and output ports, the memories and timer T1. Timer T1 is an internal timer counter inside the microprocessor 30. It provides the internal clock that counts 64 for every 3.7 milliseconds. The Timer T1 interrupt signal is generated when the 64^{th} count is detected and the timing cycle is restarted. If the Timer T1 is not interrupted, the system recycles. If Timer T1 is interrupted, microprocessor 30 determines whether a sensor signal should be transmitted. Microprocessor 30 counts 14 interrupt signals and the sensor will transmit pulses every 51.8 milliseconds, approximately 20 transmission pulses per second. If yes, microprocessor 30 determines whether the sensor 16 has previously received pulses. If yes, pre-defined sensor pulses are transmitted, the last received data is shifted into memory and the timer T0 is changed for control output tone according to the data indicating that the device detects an object in the distance. The tone changes as the distance varies. The timer T0 regulates the frequency and duration of the tone as the distance changes. If previous pulses have not been received, the transmit pulses are scanned and the last data is shifted into memory. It should be noted that for best detection of obstacle distance, the number of pulses transmitted will change with the distance data detected. If no echos are received from the obstacle, no data is detected by the device and the device will increase the number of transmission pulses step by step in order to strengthen echo detection. If the microprocessor 30 determines that pulses should not be transmitted, the T0 timer is changed for control output tone according to the stored data. After the T0 timer is changed, microprocessor 30 continually determines if pulses have been received. If yes, the data is stored in temporary memory and the data is manipulated since interference or an abrupt change in environment may occur, the detected data would be abnormal and thus data manipulation will produce a steady and reliable output. The next sequence of transmit pulses are set according to the data and the data trend is analyzed in different flags and the output data consolidated. The output data is then classified different stages (the data trend is classified as either a decrease in distance, stationary (no motion of obstacle or vehicle) and an increase in distance; the data trend ensures that the received data are in a logical order and that unreasonable data will be discarded) and the output voice and tone is then determined. The output voice and tone is then generated. Once voice is complete and Timer T1 interrupted, the tone is changed and the process steps noted hereinabove are repeated. Note that the speaker produces both speech indicating the distance detected and a changing tone that alerts the driver that the distance is changing.

Microprocessor 30 measures the time between transmitting a pulse train and when the echos are received and makes the calculation based on the formula d=velocity of sound×time of travel.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A vehicle alert backup system, said vehicle having a battery and a driver comprising;
a main control unit coupled to said vehicle battery;
a sensor unit mounted to the rear of said vehicle for transmitting and receiving ultrasonic pulses, said sensor unit being coupled to said main control unit; and
a speaker mounted in the vehicle cabin and coupled to said control unit, said speaker providing a vocal message to the vehicle driver announcing the distance to an obstacle detected behind said vehicle by said sensor unit.

2. The system of claim 1 wherein said main control unit is activated when said vehicle is in reverse.

3. The system of claim 1 wherein said speaker generates a variable tone, the generated tone being dependent on the distance to said obstacle.

4. The system of claim 1 wherein said main control unit includes a microprocessor which calculates said distance based on the elapsed time between said transmitted and received ultrasonic pulses.
